(19) United States
(12) Patent Application Publication
(10) Pub. No.: US 2012/0131471 A1
(43) Pub. Date: May 24, 2012

(54) METHODS AND APPARATUSES FOR PROTECTING PRIVACY OF CONTENT

(75) Inventors: Michiel Terlouw, Helsinki (FI); John Evans, Helsinki (FI); Mikko Flykt, Helsinki (FI)

(73) Assignee: Nokia Corporation

(21) Appl. No.: 12/949,259

(22) Filed: Nov. 18, 2010

(51) Int. Cl. G06F 3/01; G06F 3/048

(52) U.S. Cl. 715/741

(57) ABSTRACT

Methods and apparatuses are provided for protecting privacy of content. A method may include determining a predefined trigger for activating a private mode. The method may further include, responsive to the determined trigger, causing content at a display location to be concealed by causing display of an altered representation of the content at the display location. Corresponding apparatuses are also provided.

### TECHNOLOGICAL FIELD

Example embodiments of the present invention relate generally to user interface technology and, more particularly, relate to methods and apparatuses for protecting privacy of content.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

### BRIEF SUMMARY

Methods, apparatuses, and computer program products are herein provided for protecting privacy of content. Methods, apparatuses, and computer program products in accordance with various embodiments may provide several advantages to computing devices, content providers, and computing device users. Some example embodiments provide a private mode wherein one or more portions of displayed content are concealed by display of altered representations of the content. In some example embodiments, the altered representations of the content are displayed in the same display location(s) in which the concealed content was displayed prior to activation of the private mode. In this regard, such example embodiments may serve to conceal private content while still displaying non-private content, such as application controls. Accordingly, for example, some example embodiments may advantageously protect the privacy of a user's private content in an application user interface while enabling the user to show the application user interface to another individual.

In a first example embodiment, a method is provided, which comprises determining a predefined trigger for activating a private mode. The method of this example embodiment further comprises, responsive to the determined trigger, causing content at a display location to be concealed by causing display of an altered representation of the content at the display location.

In another example embodiment, an apparatus comprising at least one processor and at least one memory storing computer program code is provided. The at least one memory and stored computer program code are configured, with the at least one processor, to cause the apparatus of this example embodiment to at least determine a predefined trigger for activating a private mode. The at least one memory and stored computer program code are configured, with the at least one processor, to further cause the apparatus of this example embodiment, responsive to the determined trigger, to cause content at a display location to be concealed by causing display of an altered representation of the content at the display location.

In another example embodiment, a computer program product is provided. The computer program product of this example embodiment includes at least one computer-readable storage medium having computer-readable program instructions stored therein. The program instructions of this example embodiment comprise program instructions configured to determine a predefined trigger for activating a private mode. The program instructions of this example embodiment further comprise program instructions configured, responsive to the determined trigger, to cause content at a display location to be concealed by causing display of an altered representation of the content at the display location.

In another example embodiment, an apparatus is provided that comprises means for determining a predefined trigger for activating a private mode. The apparatus of this example embodiment further comprises means for, responsive to the determined trigger, causing content at a display location to be concealed by causing display of an altered representation of the content at the display location.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus for protecting privacy of content according to an example embodiment;

FIG. 2 is a schematic block diagram of a mobile terminal according to an example embodiment;

FIG. 3 illustrates a system for protecting privacy of content according to an example embodiment;

FIGS. 4a-4b illustrate content display in a private mode according to an example embodiment;

FIGS. 5a-5d illustrate an example touch gesture for activating a private mode and concealing content according to an example embodiment;

FIG. 6 illustrates a flowchart according to an example method for protecting privacy of content according to an example embodiment; and

FIG. 7 illustrates a flowchart according to an example method for protecting privacy of content according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

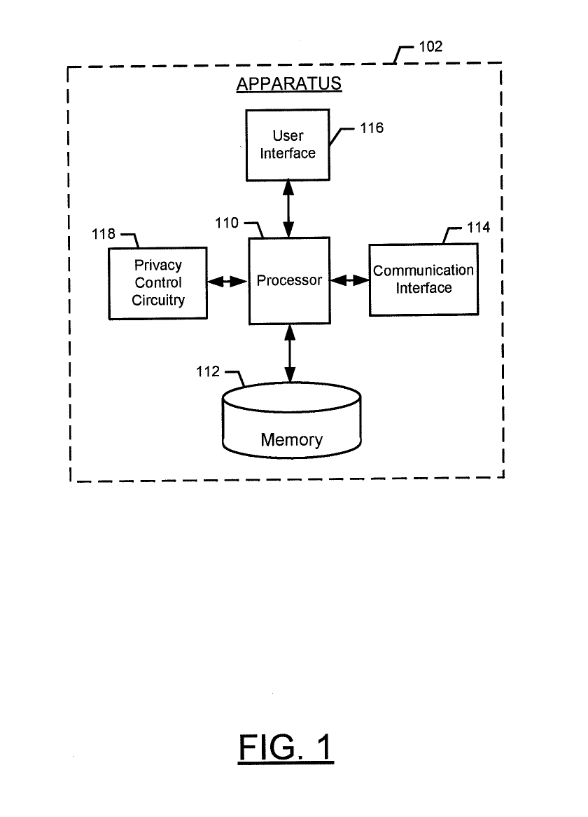

FIG. 1 illustrates a block diagram of an apparatus 102 for protecting privacy of content according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for protecting privacy of content, other configurations may also be used to implement embodiments of the present invention.

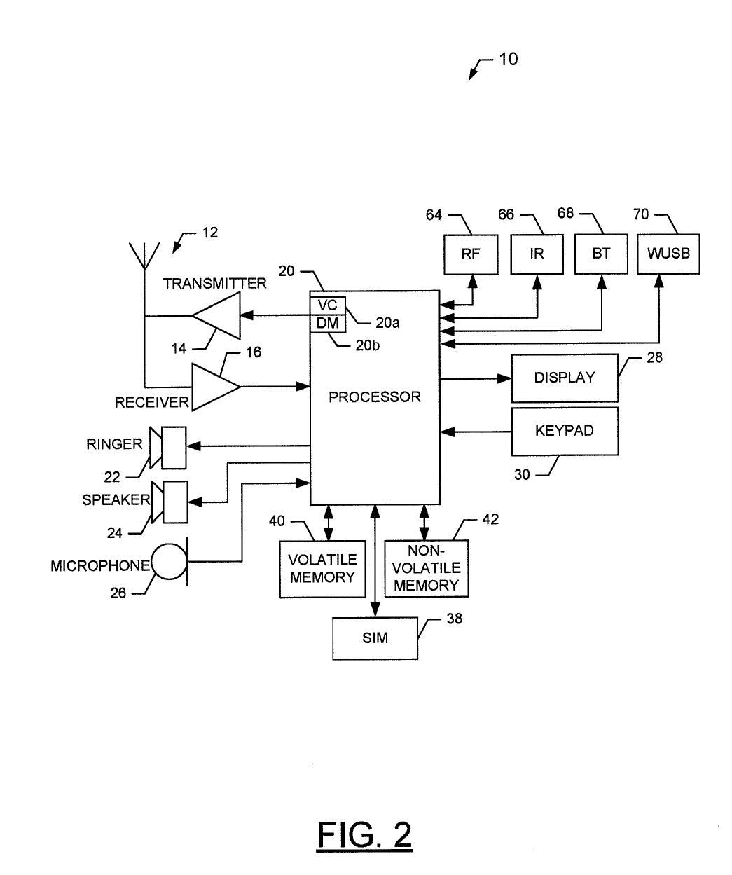

The apparatus 102 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, chipset, a computing device comprising a chipset, any combination thereof, and/or the like. In this regard, the apparatus 102 may comprise any computing device or other apparatus that is configured to display and/or control display of content. In an example embodiment, the apparatus 102 is embodied as a mobile computing device, such as a mobile terminal, such as that illustrated in FIG. 2.

In this regard, FIG. 2 illustrates a block diagram of a mobile terminal 10 representative of one embodiment of an apparatus 102. It should be understood, however, that the mobile terminal 10 illustrated and hereinafter described is merely illustrative of one type of apparatus 102 that may implement and/or benefit from various embodiments of the invention and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, or privacy control circuitry 118. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, and/or privacy control circuitry 118 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, user data, application data, service data, and/or the like. This stored information may be stored and/or used by the privacy control circuitry 118 during the course of performing its functionalities.

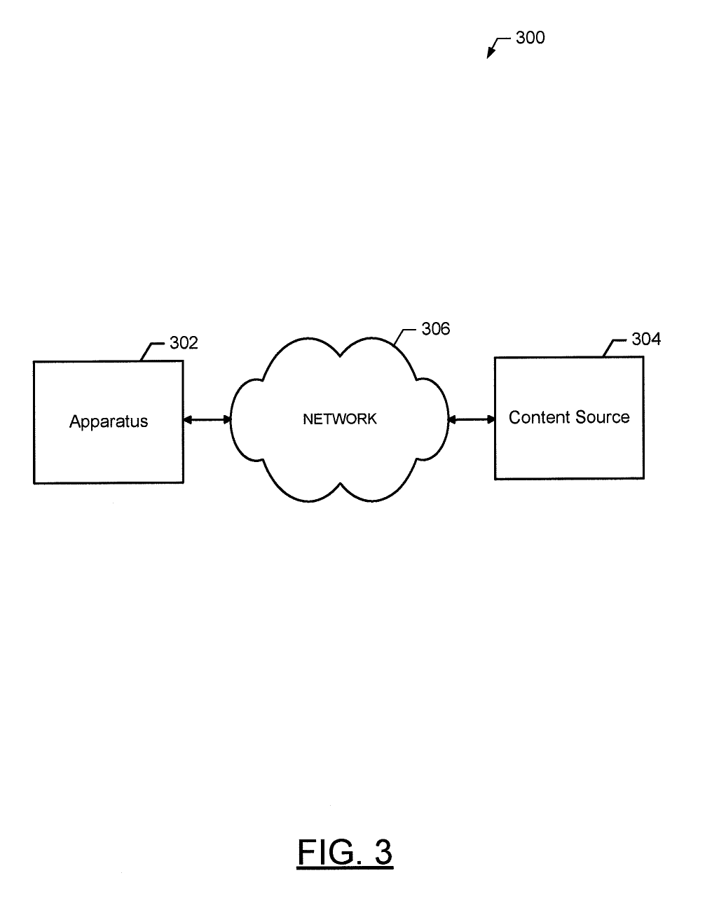

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content and/or the like) over a network (e.g., the network 306 illustrated in FIG. 3) from a server or other content source (e.g., the content source 304). The communication interface 114 may additionally be in communication with the memory 112, user interface 116, and/or privacy control circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the user interface 116 comprises or is in communication with a display, the display may comprise, for example, a cathode ray tube (CRT) display, a plasma display panel (PDP), a liquid crystal display (LCD), a light-emitting diode (LED), an organic light-emitting diode display (OLED), a projector (e.g., a projector configured to project a display on a projection screen, wall, and/or other object), a holographic display, or the like. In embodiments wherein the user interface 116 comprises a touch screen display, the user interface 116 may additionally be configured to detect and/or receive an indication of a touch gesture or other input to the touch screen display. The user interface 116 may be in communication with the memory 112, communication interface 114, and/or privacy control circuitry 118, such as via a bus.

The privacy control circuitry 118 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In embodiments wherein the privacy control circuitry 118 is embodied separately from the processor 110, the privacy control circuitry 118 may be in communication with the processor 110. The privacy control circuitry 118 may further be in communication with one or more of the memory 112, communication interface 114, or user interface 116, such as via a bus.

FIG. 3 illustrates a system 300 for protecting privacy of content according to an example embodiment of the invention. The system 300 may comprise an apparatus 302 and a content source 304 configured to communicate over the network 306. The apparatus 302 may, for example, comprise an embodiment of the apparatus 102 wherein the apparatus 102 is configured to communicate with a remote content source 304 over a network 306 to access content available from the content source 304. The accessed content may, for example, be displayed on a display by the apparatus 102. The content source 304 may comprise any computing device configured to provide content to the apparatus 302 over the network 306. In this regard, the content source 304 may comprise, for example, a network attached storage device, a server, a desktop computer, laptop computer, mobile terminal, mobile computer, mobile phone, mobile communication device, audio/video player, any combination thereof, and/or the like that is configured to provide and/or otherwise share content with the apparatus 302. The network 306 may comprise a wireline network, wireless network (e.g., a cellular network, wireless local area network, wireless wide area network, some combination thereof, or the like), or a combination thereof, and in one embodiment comprises the internet.

Accordingly, it will be appreciated that content described to be displayed and concealed in accordance with various example embodiments may comprise content received, obtained, and/or accessed by the apparatus 102 from a content source 304 over a network 306. Additionally or alternatively, such content may comprise content that is locally stored at the apparatus 302, such as in the memory 112.

In some example embodiments, the privacy control circuitry 118 is configured to determine a predefined trigger for activating a private mode. The predefined trigger may, for example, comprise a detected predefined user input to the user interface 116. As an example, in embodiments wherein the apparatus 102 comprises or is in operative communication with a touch screen display, the predefined user input may comprise a predefined touch gesture. As an example, the predefined touch gesture may comprise a pinch gesture wherein two fingers, styli, or the like are moved toward each, as in a pinching motion. As another example, the predefined touch gesture may comprise a touch and hold gesture, wherein a finger, stylus, or the like is touched to and held on the touch screen display (e.g., within a predefined detection proximity of the touch screen display). In some example embodiments, the touch and hold gesture may further comprise or may be followed by a swipe gesture (e.g., a touch and hold and swipe gesture). The swipe gesture may comprise swiping the finger, stylus, or the like which was used to make the touch and hold gesture along a path on the touch screen display. Alternatively the swipe gesture may comprise swiping a second finger, stylus, or the like along a path on the touch screen display while maintaining the touch and hold gesture with a first finger, stylus, or the like. As further examples, the predefined user input may comprise selection of a menu command to activate the private mode; selection of a predefined key, button, soft key, or the like for activating the private mode; a predefined input using a mouse or other input device; some combination thereof; or the like.

As an additional example, the apparatus 102 may comprise or may otherwise be in operative communication with a camera. In embodiments wherein the apparatus 102 comprises a mobile terminal, such as the mobile terminal 10, the camera may comprise a front-facing camera. The camera may be configured to capture an image of a user of the apparatus 102. The privacy control circuitry 118 may be configured to determine whether a user captured in an image is a user authorized to view displayed content. The privacy control circuitry 118 may be configured to determine whether a user captured in an image is an authorized user by using any appropriate face recognition technique. As an example, the privacy control circuitry 118 may be configured to compare a captured image to one or more stored images of an authorized user(s). The set of authorized user(s) may vary depending on the content being displayed. In this regard, for example, a first set of one or more users may be authorized to view a first type of content and a second set of one or more users may be authorized to view a second type of content. Accordingly, the privacy control circuitry 118 may be configured to determine whether a user is an authorized user based at least in part on the content being displayed. A determination by the privacy control circuitry 118 that a user captured in an image is not an authorized may comprise a predefined trigger for activating the private mode.

Similarly, as another example, the apparatus 102 may comprise or may otherwise be in operative communication with a biometric sensor, such as a fingerprint sensor. The privacy control circuitry 118 may determine whether a user of the apparatus 102 is an authorized user based at least in part on biometric data (e.g., a fingerprint) captured from the user. As discussed with respect to embodiments implementing face recognition, a set of one or more authorized users may be dependent upon the content being displayed. Accordingly, the privacy control circuitry 118 may be configured to determine whether a user is an authorized user based at least in part on the content being displayed. A determination by the privacy control circuitry 118 that the user is not an authorized may comprise a predefined trigger for activating the private mode.

The privacy control circuitry 118 may be further configured, responsive to the predefined trigger, to cause displayed content to be concealed. The content which is concealed may, for example, comprise concealment of all visible displayed content (e.g., the entirety of a display screen). As another example, the concealed content may comprise concealment of only a portion of visibly displayed content such that only one or more portions of content visible on a display are concealed. The concealed content may additionally or alternatively comprise concealment of content that is not visibly displayed. Examples of non-visibly displayed content that may be concealed include content rendered in a portion of a user interface that is not presently visible on a display (e.g., a portion of an application window that is outside of the confines of a display size), a photo or portion thereof in an open photo album that is not being viewed when the private mode is activated, or the like. In some example embodiments wherein only visibly displayed content is concealed when private mode is activated, a user may scroll to a previously non-visible portion of an interface and again provide a predefined input for activating the private mode to cause concealment of the additional content.

The privacy control circuitry 118 may be configured to cause content to be concealed by causing display of an altered representation of the content in place of the content. In this regard, content to be concealed may be displayed at a display location (e.g., a defined coordinate, area, or the like, of a display) and an altered representation of the content may, for example, be displayed in place of or may be superimposed on top of the content at the display location. The altered representation of the content may comprise any text, graphic, and/or the like that may cover or otherwise conceal the content such that the content may not be readily viewed. As an example, an altered representation of concealed content may comprise a blurred representation of the content. As a further example, an altered representation of concealed content may comprise a replacement image displayed in place of the content, display of an opaque color block over or in place of the content, and/or the like. As another example, an altered representation of content may comprise replacement of concealed text content with a series of one or more characters (e.g., a string of random characters, a string of symbols, such as *'s, or the like), which do not convey the meaning of the concealed text content.

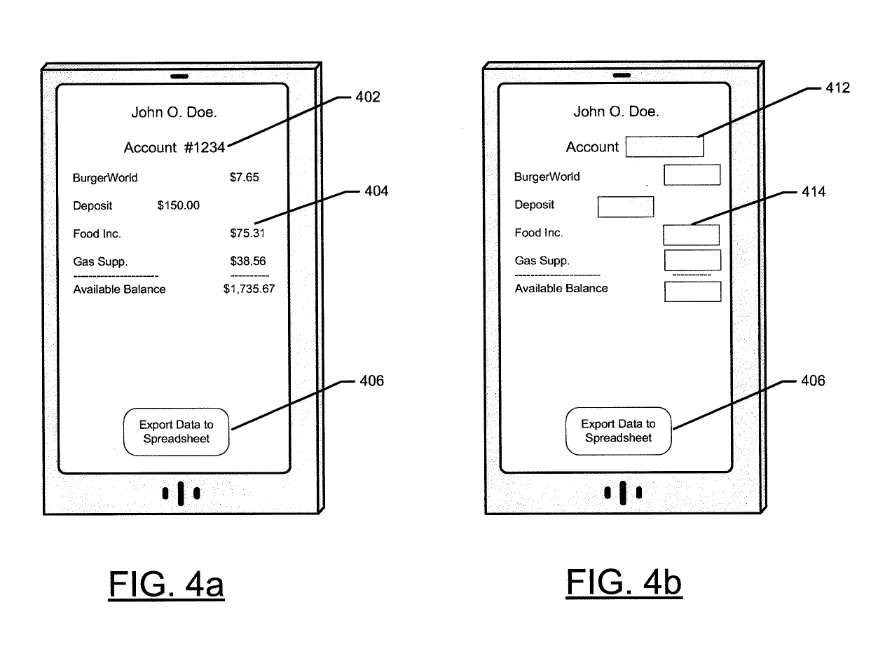

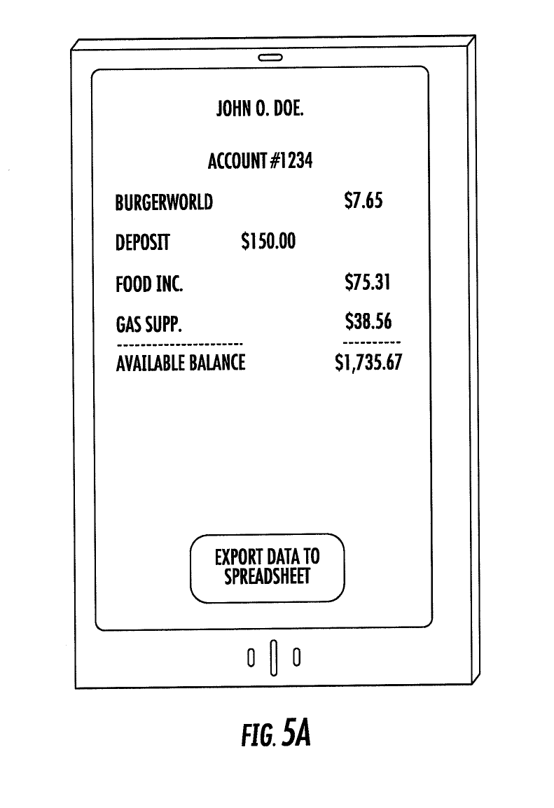

Referring now to FIGS. 4a and 4b, FIGS. 4a and 4b illustrate content display in a private mode according to an example embodiment. Referring first to FIG. 4a, an application displaying bank account transactions is displayed. The application displays sensitive content related to the bank account, including the user's account number 402 and a plurality of transaction values, such as the transaction value 404. In response to a private mode being activated, the privacy control circuitry 118 may cause concealment of this sensitive content. With reference to FIG. 4b, it may be seen that the account number 402 has been replaced with the gray block 412, which serves as an altered representation of the account number 402, which conceals the account number 402. Similarly, the transaction values have been concealed with grey blocks, such as the grey block 414. However, as seen in FIG. 4b, the overall application user interface is still visible. For example, in some example embodiments, non-private content and application interface controls, such as the control 406 may not be concealed by the privacy control circuitry 118 when the private mode is activated. In this regard in some example embodiments, content at a display location of a graphical user interface, such as an application user interface, may be concealed while at least a portion of the graphical user interface is not altered. Accordingly, a user may show an application user interface, such as for tutorial purposes, to another individual while not exposing the user's sensitive private content.

In some example embodiments, the privacy control circuitry 118 may be further configured to determine a display location of content to be concealed. In this regard, a predefined trigger for activating private mode may comprise or otherwise associated with a definition of a display location in which content is to be concealed. The privacy control circuitry 118 may accordingly be configured to determine a display location(s) of content to be concealed based on a determined predefined trigger and/or based on an input associated with the predefined trigger. For example, in embodiments wherein a pinch gesture serves as a trigger for activating private mode, the display location of content to be concealed may be defined by an area defined by the area between the user's pinching fingers. As another example, a display location of content to be concealed may be defined by free form selection of one or more display locations on a display. For example, a user may use a finger, stylus, arrow keys, mouse, and/or the like to select content and/or define boundaries of display locations having content to be concealed in the private mode. As an example, a user may select content to be obscured by making a swiping gesture over the content on a touch screen display. In this regard, the boundaries of the display location(s) having content to be concealed may be defined at least in part by the display location(s) including the content covered by the swiping gesture. The swiping gesture may, for example, follow a touch and hold gesture for activating the privacy mode. In some example embodiments, a privacy mode may be activated and subsequent to activation of the privacy mode, a user may define display locations to be concealed through free form selection of the areas. Accordingly, where a trigger for activating a private mode is said to comprise a definition of a display location of content to be concealed, the trigger for activating the private mode may, itself, define the display location, or a subsequent gesture, input, selection, and/or the like may define the display location.

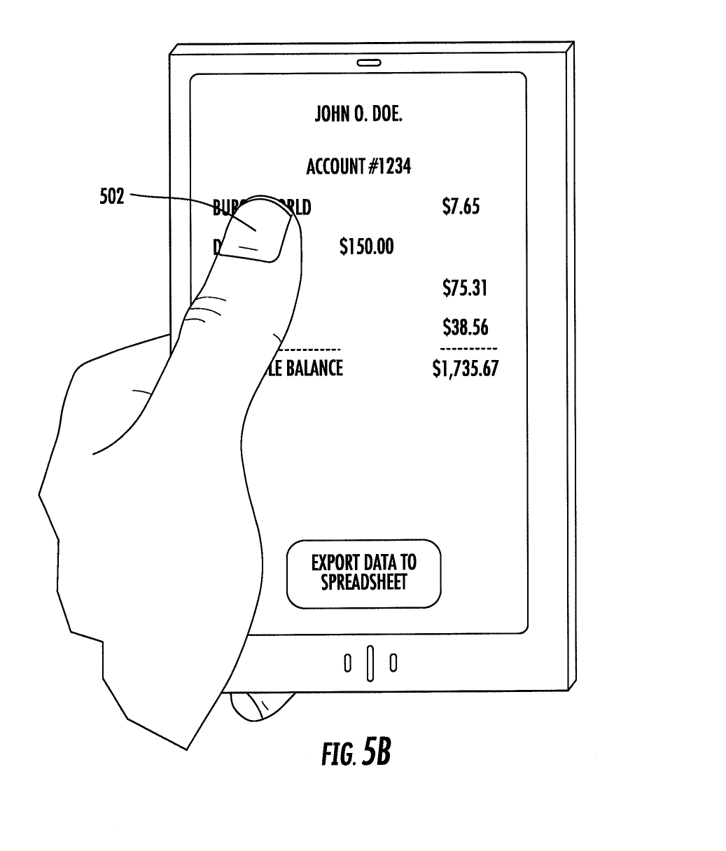

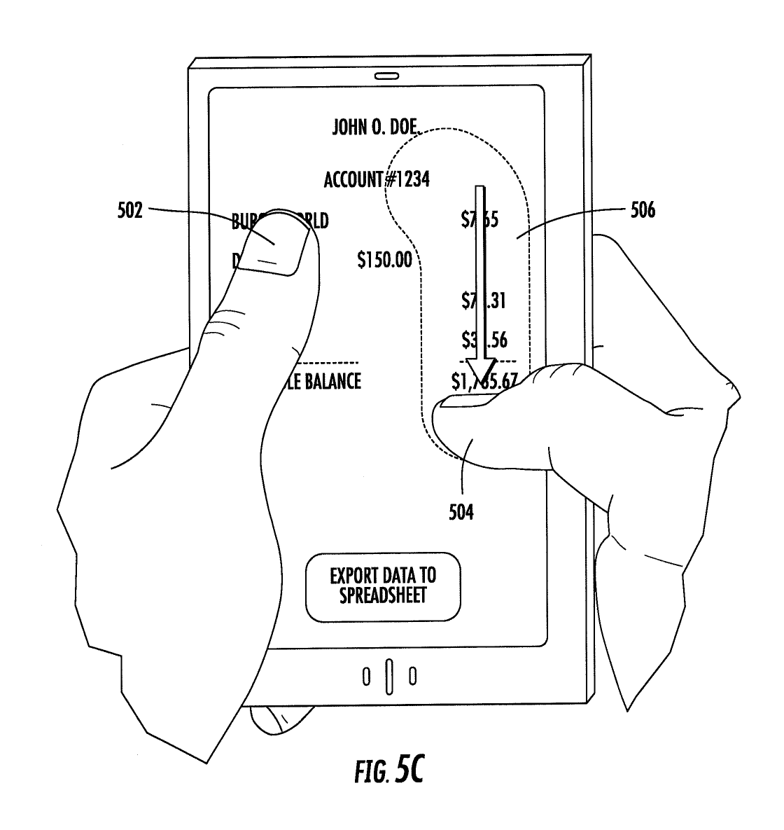

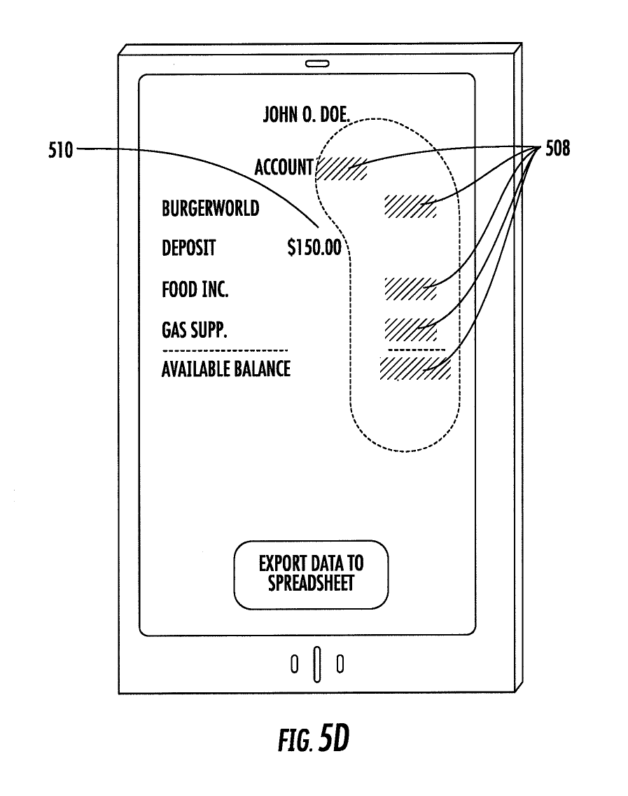

Referring now to FIGS. 5a-5d, FIGS. 5a-5d illustrate an example touch gesture for activating a private mode and concealing content according to an example embodiment. In this regard, FIGS. 5a-5d illustrate an example of a touch and hold and swipe gesture according to an example embodiment, wherein a private mode may be activated with a touch and hold gesture and content to be concealed may be selected with a swipe gesture. Referring first to FIG. 5a, the bank account transaction application display of FIG. 4a is displayed on a touch screen display. In order to activate private mode in accordance with the example embodiment illustrated in FIGS. 5a-5d, a user may touch and hold a finger, stylus, or the like to any portion of the touch screen display. Referring to FIG. 5b, a user has touched and held his left thumb 502 to the display in order to activate private mode. Referring now to FIG. 5c, the user may select content to be concealed by swiping over content that the user desires to conceal while maintaining the touch and hold gesture. Accordingly, FIG. 5c illustrates the user maintaining the touch and hold gesture with his left thumb 502 while swiping his right thumb 504 along a path 506, which defines an area in which content is to be concealed. As may be seen in FIG. 5d the content items 508, which were within the path 506 have been concealed with grey blocks, as similarly illustrated in FIG. 4b. However, unlike in FIG. 4b, the deposit transaction value, labeled 510 in FIG. 5d, is not concealed, because the deposit transaction value 510 was not traversed by the path 506 of the swipe gesture.

In some example embodiments, a display location may be defined that includes content extending beyond an area of an interface visibly displayed. For example, if a user defines an area extending to the boundaries of a display screen, such as by selecting a portion of a column of text extending to the boundary of the display screen the privacy control circuitry 118 may determine the display location to include the entire column of text, inclusive of a portion of the column of text extending beyond the display screen. As another example, if a user selects a particular individual's face in a photo in a photo album, the privacy control circuitry 118 may determine the display location to include each instance of that individual's face in the photo album. In this regard, the individual may be tagged in a photo in which the individual's face is selected and the privacy control circuitry 118 may determine the display locations of the individual in other photos in the photo album by identifying display locations in other photos in which the individual is tagged.

In some example embodiments, the privacy control circuitry 118 may be configured to analyze content within a display location to determine which of the content comprises private content to be concealed. For example, private content may comprise user-specific or other sensitive content, such as the account number 402 and the transaction value 404. Non-private content may comprise non-sensitive data, such as application controls (e.g., the application interface control 406). The privacy control circuitry 118 may accordingly be configured in such example embodiments to cause only the private content at a display location to be concealed while any non-private content at the display location remains visible.

After content has been concealed attendant to activation of a private mode, a user may provide a predefined input as a trigger for revealing at least some of the concealed content. The privacy control circuitry 118 may accordingly be configured to determine a predefined trigger for revealing concealed content and, responsive thereto, may cause cessation of display of the altered representation of the content at the display location and causing the content at the display location to be revealed. As an example, a user may select to deactivate the private mode by selecting a menu option. As another example, a user may select a predefined button, key, soft key, or the like for deactivating the private mode. In some example embodiments a secure private mode may be activated, wherein the user may be prompted to provide a predefined PIN (private identification number) code or other password to verify the user's identity before the private mode can be deactivated. As another example wherein a secure private mode may be activated, the user may provide a predefined touch gesture signature as a verification of the user's identity before the private mode may be deactivated. As still a further example, a user may provide input (e.g., a fingerprint) to a biometric sensor and the privacy control circuitry 118 may determine whether the user is an authorized user by comparing the captured biometric input to pre-stored biometric data for one or more authorized users. In such example embodiments, a user may select an option to activate a secure private mode when activating the private mode. The privacy control circuitry 118 may accordingly be configured to authenticate the password prior to revealing any concealed content when a secure private mode is activated.

As another example, the apparatus 102 may comprise or may otherwise be in operative communication with a camera. In embodiments wherein the apparatus 102 comprises a mobile terminal, such as the mobile terminal 10, the camera may comprise a front-facing camera. The camera may be configured to capture an image of a user of the apparatus 102. The privacy control circuitry 118 may be configured to determine whether a user captured in an image is a user authorized to view displayed content. The privacy control circuitry 118 may be configured to determine whether a user captured in an image is an authorized user by using any appropriate face recognition technique. As an example, the privacy control circuitry 118 may be configured to compare a captured image to one or more stored images of an authorized user(s). A determination by the privacy control circuitry 118 determines that a user of the apparatus 102 captured in an image is an authorized user may comprise a predefined trigger for revealing concealed content. The set of authorized user(s) may vary depending on the content being displayed. In this regard, for example, a first set of one or more users may be authorized to view a first type of content and a second set of one or more users may be authorized to view a second type of content. Accordingly, the privacy control circuitry 118 may be configured to determine whether a user is an authorized user based at least in part on the content being concealed. In some example embodiments, if content is revealed due to identification of an authorized user, the privacy control circuitry 118 may be configured to cause the content to be concealed again responsive to a subsequent determination that the authorized user is no longer within the field of view of the camera (e.g., that the authorized user is no longer using the apparatus 102).

In some example embodiments, a private mode may be semi-permanent such that content remains concealed within an application even if the application is closed and reopened until the user selects to reveal the concealed content. In some example embodiments, a user may select a subset of concealed content to be revealed, such as through free form selection of concealed content. The privacy control circuitry 118 may accordingly be configured in such example embodiments to cause the selected concealed content to be revealed.

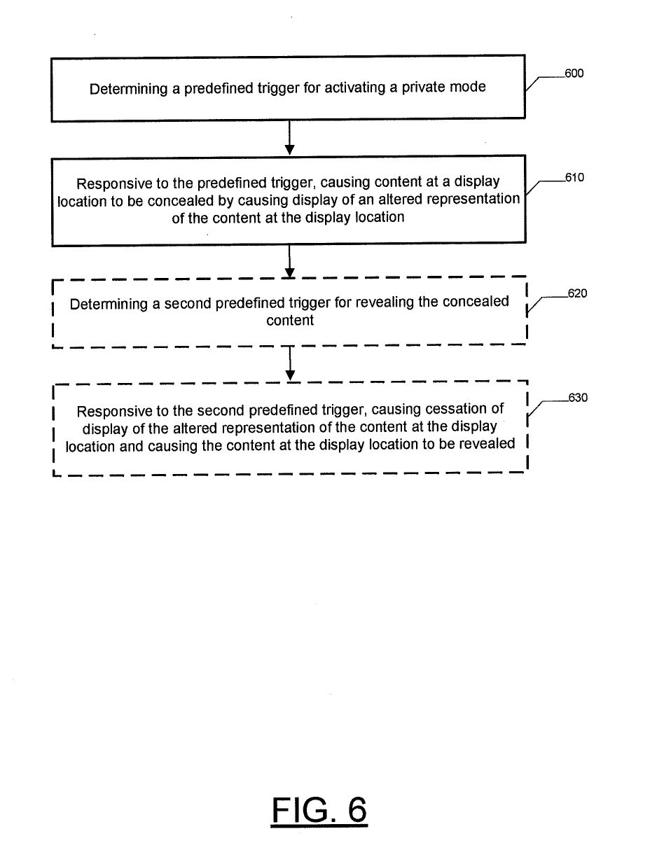

FIG. 6 illustrates a flowchart according to an example method for protecting privacy of content according to an example embodiment. The operations illustrated in and described with respect to FIG. 6 may, for example, be performed by, with the assistance of, and/or under the control of one or more of the processor 110, memory 112, communication interface 114, user interface 116, or privacy control circuitry 118. Operation 600 may comprise determining a predefined trigger for activating a private mode. The processor 110, memory 112, user interface 116, and/or privacy control circuitry 118 may, for example, provide means for performing operation 600. Operation 610 may comprise, in response to the trigger, causing content at a display location to be concealed by causing display of an altered representation of the content at the display location. The processor 110, memory 112, user interface 116, and/or privacy control circuitry 118 may, for example, provide means for performing operation 610.

The method may optionally further comprise operation 620, which may comprise determining a second predefined trigger for revealing the concealed content. The processor 110, memory 112, user interface 116, and/or privacy control circuitry 118 may, for example, provide means for performing operation 620. Operation 630 may comprise, responsive to the second predefined trigger, causing cessation of display of the altered representation of the content at the display location and causing the content at the display location to be revealed. The processor 110, memory 112, user interface 116, and/or privacy control circuitry 118 may, for example, provide means for performing operation 630.

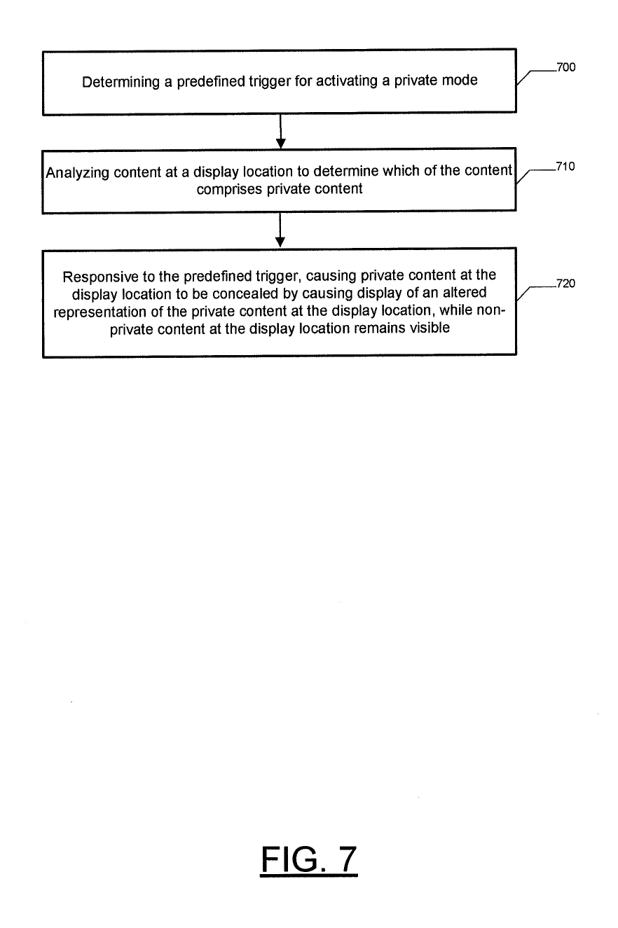

FIG. 7 illustrates a flowchart according to an example method for protecting privacy of content according to an example embodiment. The operations illustrated in and described with respect to FIG. 7 may, for example, be performed by, with the assistance of, and/or under the control of one or more of the processor 110, memory 112, communication interface 114, user interface 116, or privacy control circuitry 118. Operation 700 may comprise determining a predefined trigger for activating a private mode. The processor 110, memory 112, user interface 116, and/or privacy control circuitry 118 may, for example, provide means for performing operation 700. Operation 710 may comprise analyzing content at a display location to determine which of the content comprises private content. The processor 110, memory 112, and/or privacy control circuitry 118 may, for example, provide means for performing operation 710. Operation 720 may comprise, responsive to the predefined trigger, causing private content at the display location to be concealed by causing display of an altered representation of the private content at the display location, while non-private content at the display location remains visible. The processor 110, memory 112, user interface 116, and/or privacy control circuitry 118 may, for example, provide means for performing operation 720.

FIGS. 6-7 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining a predefined trigger for activating a private mode; and
responsive to the determined trigger, causing content at a display location to be concealed by causing display of an altered representation of the content at the display location.

2. The method of claim 1, wherein causing content at the display location to be concealed comprises causing content at a display location of a graphical user interface to be concealed while at least a portion of the graphical user interface is not altered.

3. The method of claim 2, wherein the graphical user interface comprises an application user interface.

4. The method of claim 1, wherein the trigger comprises a definition of the display location, the method further comprising:
determining the display location based at least in part on the definition of the display location.

5. The method of claim 1, further comprising:
analyzing content displayed at the display location to determine which of the content comprises private content; and
wherein causing content at a display location to be concealed comprises causing only the private content at the display location to be concealed while any non-private content at the display location remains visible.

6. The method of claim 5, wherein private content comprises user-specific content, and wherein non-private content comprises application controls.

7. The method of claim 1, further comprising:
determining a second predefined trigger for revealing the concealed content; and
in response to the second predefined trigger, causing cessation of display of the altered representation of the content at the display location and causing the content at the display location to be revealed.

8. The method of claim 1, wherein the altered representation of the content comprises one or more of a blurred representation of the content, a replacement image displayed in place of the content, or a representation of the content as a series of one or more characters.

9. The method of claim 1, wherein determining a predefined trigger for activating a private mode comprises determining a predefined touch gesture for activating the private mode.

10. The method of claim 9, wherein the predefined touch gesture comprises a touch and hold and swipe gesture.

11. An apparatus comprising at least one processor and at least one memory storing computer program code, wherein the at least one memory and stored computer program code are configured, with the at least one processor, to cause the apparatus to at least:
determine a predefined trigger for activating a private mode; and
responsive to the determined trigger, cause content at a display location to be concealed by causing display of an altered representation of the content at the display location.

12. The apparatus of claim 11, wherein the at least one memory and stored computer program code are configured, with the at least one processor, to cause the apparatus to cause content at the display location to be concealed by causing content at a display location of a graphical user interface to be concealed while at least a portion of the graphical user interface is not altered.

13. The apparatus of claim 11, wherein the trigger comprises a definition of the display location, and wherein the at least one memory and stored computer program code are configured, with the at least one processor, to further cause the apparatus to:
determine the display location based at least in part on the definition of the display location.

14. The apparatus of claim 11, wherein the at least one memory and stored computer program code are configured, with the at least one processor, to further cause the apparatus to:
analyze content displayed at the display location to determine which of the content comprises private content; and
cause content at a display location to be concealed by causing only the private content at the display location to be concealed while any non-private content at the display location remains visible.

15. The apparatus of claim 11, wherein the at least one memory and stored computer program code are configured, with the at least one processor, to further cause the apparatus to:
determine a second predefined trigger for revealing the concealed content; and
in response to the second predefined trigger, cause cessation of display of the altered representation of the content at the display location and cause the content at the display location to be revealed.

16. The apparatus of claim 11, wherein the altered representation of the content comprises one or more of a blurred representation of the content, a replacement image displayed in place of the content, or a representation of the content as a series of one or more characters.

17. The apparatus of claim 11, wherein the at least one memory and stored computer program code are configured, with the at least one processor, to cause the apparatus to determine a predefined trigger for activating a private mode by determining a predefined touch gesture for activating the private mode.

18. The apparatus of claim 17, wherein the predefined touch gesture comprises a touch and hold and swipe gesture.

19. The apparatus according to claim 11, wherein the apparatus comprises or is embodied on a mobile computing device, the mobile computing device comprising user interface circuitry and user interface software stored on one or more of the at least one memory, wherein the user interface circuitry and user interface software are configured to:
facilitate user control of at least some functions of the mobile computing device through use of a display; and
cause at least a portion of a user interface of the mobile computing device to be displayed on the display to facilitate user control of at least some functions of the mobile computing device.

20. A computer program product comprising at least one non-transitory computer-readable storage medium having computer-readable program instructions stored therein, the computer-readable program instructions comprising:
program instructions configured to determine a predefined trigger for activating a private mode; and
program instructions configured, responsive to the determined trigger, to cause content at a display location to be concealed by causing display of an altered representation of the content at the display location.
